(19) United States
(12) Patent Application Publication
(10) Pub. No.: US 2010/0301082 A1
(43) Pub. Date: Dec. 2, 2010

(54) Securing Device

(76) Inventor: Scott W. Beckley, Highlands Ranch, CO (US)

Correspondence Address: HARSHAW RESEARCH, INC., 210 W. TECUMSEH STREET, OTTAWA, KS, 66067, US

(21) Appl. No.: 12/475,950

(22) Filed: Jun. 1, 2009

(51) Int. Cl. B60R 9/10

(52) U.S. Cl. 224/519; 224/535; 224/536

(57) ABSTRACT

A securing device includes a frame having first and second pivot points spaced apart from one another, a travel member extending vertically between the first and second pivot points and movable generally linearly between a lowermost position and an uppermost position, a first arm pivotally coupled to the frame at the first pivot point, and a second arm pivotally coupled to the frame at the second pivot point. First and second intermediate links are pivotally coupled to the first and second arms, respectively, and pivotally coupled to the travel member. A biasing element imparts force directly or indirectly upon the first intermediate link to maintain the travel member at the lowermost position when the travel member is at the lowermost position, the force biasing the first intermediate link to impede the travel member from moving to the lowermost position when the travel member is not at the lowermost position.

### BACKGROUND OF THE INVENTION

This invention relates generally to locking devices and, more particularly, to a device for securing the fork of a bicycle such as to a bicycle carrier.

Bicycles are popular and useful for enjoyment, transportation, and exercise. Typically, bicycles are used in close proximity to one's residence and stored in a garage when not in use. However, it is sometimes desirable to transport a bicycle to another location for use, such as to a park, on vacation, or even to the site of a bicycle race. Although a bicycle may be transported in the bed of a pickup truck or even in the trunk of a car, it is sometimes preferred to transport the bicycle using a rack. Securely attaching the bicycle to the rack is important during transport as well as to prevent theft.

Various devices have been proposed in the art for bicycle carriers for automobiles that enable a bicycle to be securely stowed during transport such as those that secure the forks of a bicycle frame after removal of a front wheel. Although presumably effective for their intended purposes, the existing devices and prior patents do not present a device that is user friendly in use or which adequately prevent unintended removal of the bicycle from the rack.

Therefore, it would be desirable to have a securing device that is easy to use, namely, which easily receives a fork of a bicycle frame and which actually further tightens around the fork if unintended or inadvertent removal is experienced. Further, it would be desirable to have a securing device that may be incorporated into a bicycle rack that may be mounted to a trailer hitch of an automobile.

### SUMMARY OF THE INVENTION

A securing device according to the present invention includes a frame having first and second pivot points spaced apart from one another, a travel member extending generally vertically between the first and second pivot points and being movable generally linearly between a lowermost position and an uppermost position, a first arm pivotally coupled to the frame at the first pivot point, and a second arm pivotally coupled to the frame at the second pivot point. First and second intermediate links are pivotally coupled to the first and second arms, respectively, and pivotally coupled to the travel member. A biasing element imparts force directly or indirectly upon the first intermediate link to maintain the travel member at the lowermost position when the travel member is at the lowermost position, the force biasing the first intermediate link to impede the travel member from moving to the lowermost position when the travel member is not at the lowermost position. The first and second arm upper sections are closer to one another when the travel member is at the lowermost position than when the travel member is at the uppermost position such that an object may be secured between the upper sections when the travel member is at the lowermost position.

Therefore, a general object of this invention is to provide a device for securing the fork of a bicycle to a bicycle carrier;

Another object of this invention is to provide a securing device, as aforesaid, that tightens its grip on a fork if unintended removal is experienced.

Still another object of this invention is to provide a securing device, as aforesaid, that may be used with or incorporated into a vehicle mounted bicycle carrier.

Yet another object of this invention is to provide a securing device, as aforesaid, that automatically tightens about an object when inserted between opposing jaws.

A further object of this invention is to provide a securing device, as aforesaid, that is user-friendly to use and economical to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a securing device according to a preferred embodiment of the present invention;

FIG. 2a is a front view of the securing device as in FIG. 1 with a traveling member at a lowermost position;

FIG. 2b is a front view of the securing device with the traveling member at a uppermost position;

FIG. 3a is an elevated view of the securing device as in FIG. 2a in operation on an inserted object;

FIG. 3b is an elevated view of the securing device as in FIG. 2b in operation on an inserted object;

FIG. 4a is a top view of the securing device as in FIG. 2a;

FIG. 4b is a sectional view taken along line 4b-4b of FIG. 4a in a configuration as in FIG. 2a;

FIG. 4c is a sectional view taken along line 4b-4b of FIG. 4a in a configuration as in FIG. 2b;

FIG. 5a is an isolated view on an enlarged scale taken from FIG. 4b;

FIG. 5b is an isolated view on an enlarged scale taken from FIG. 4c;

FIG. 6a is another isolated view on an enlarged scale taken from FIG. 4b;

FIG. 6b is another isolated view on an enlarged scale taken from FIG. 4c;

FIG. 7 is a perspective view of the securing device from another angle and in use with a lock;

FIG. 8a is an isolated view on an enlarged scale taken from FIG. 7;

FIG. 8b is an isolated view as in FIG. 8a with the lock removed and a pin in one configuration;

FIG. 8c is an isolated view as in FIG. 8b with the pin in another configuration;

FIG. 9a is a perspective view of a pair of securing devices in use with a bicycle rack in a use configuration;

FIG. 9b is a perspective view of a pair of securing devices in use with a bicycle rack in a storage configuration;

FIG. 10 is a perspective view of the securing device and bicycle rack in use upon a vehicle; and

FIG. 11 is an isolated view on an enlarged view taken from FIG. 10.

### DESCRIPTION OF THE PREFERRED EMBODIMENT

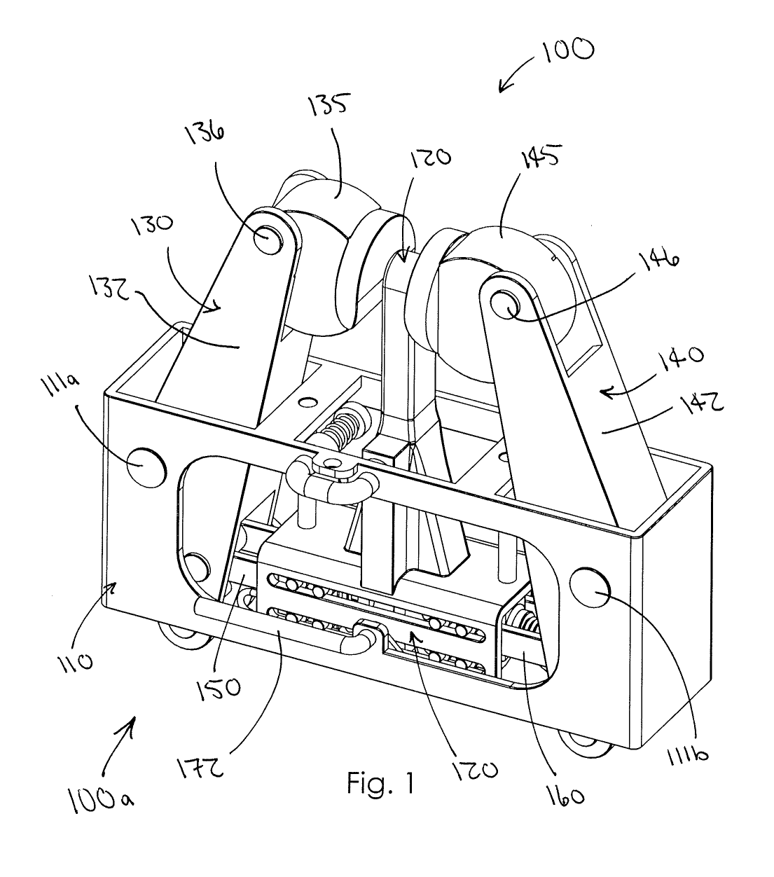

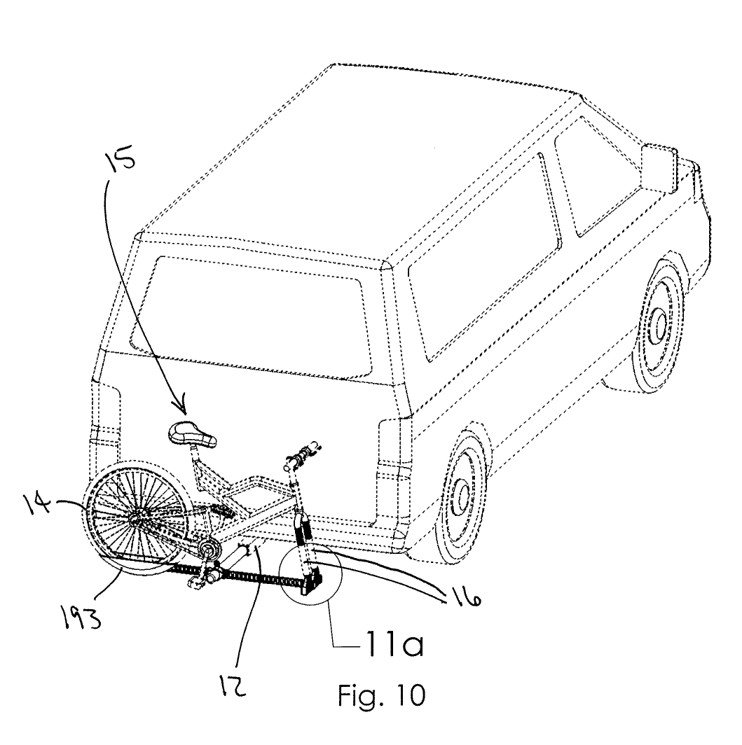

A securing device will now be described in detail with reference to FIG. 1 through FIG. 11 of the accompanying drawings. More particularly, a securing device 100 of one embodiment includes a frame 110, a travel member 120, first and second arms 130, 140, and first and second intermediate links 150, 160.

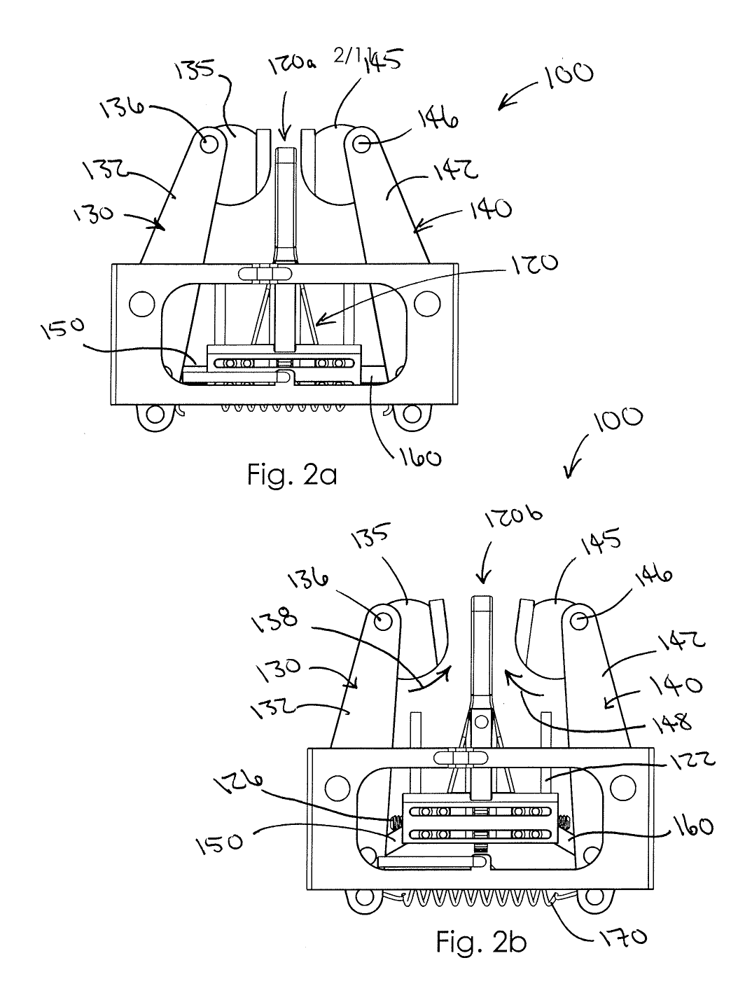

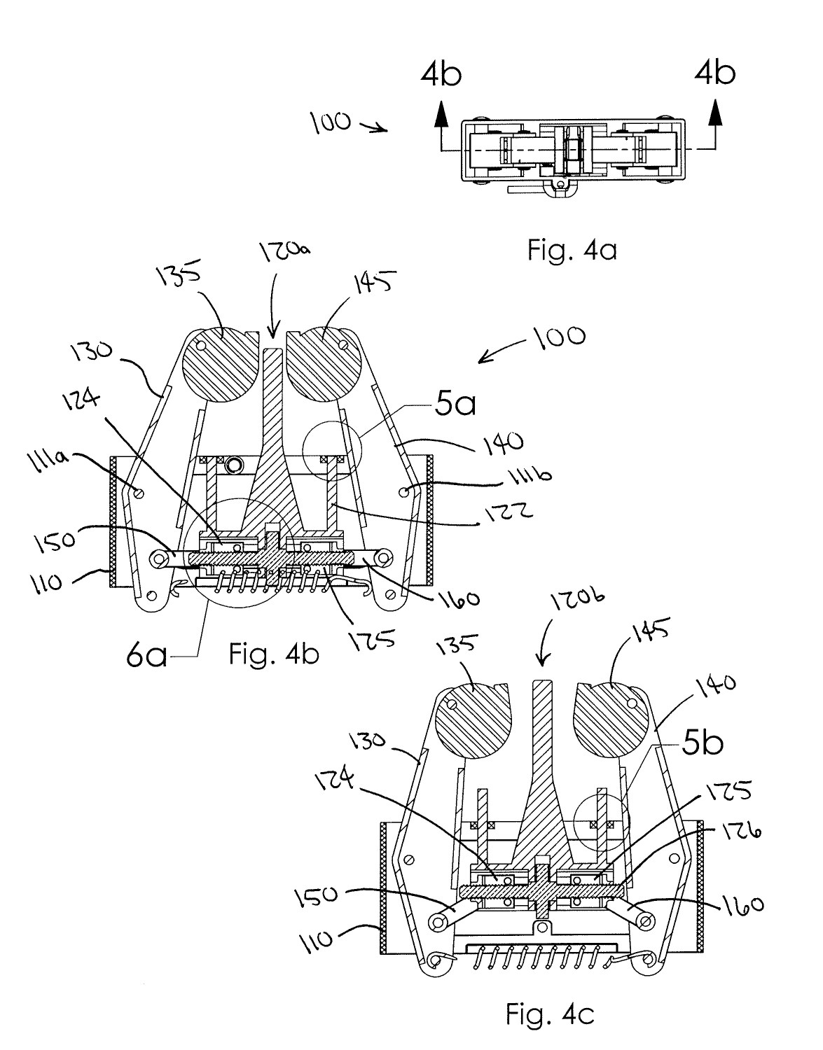

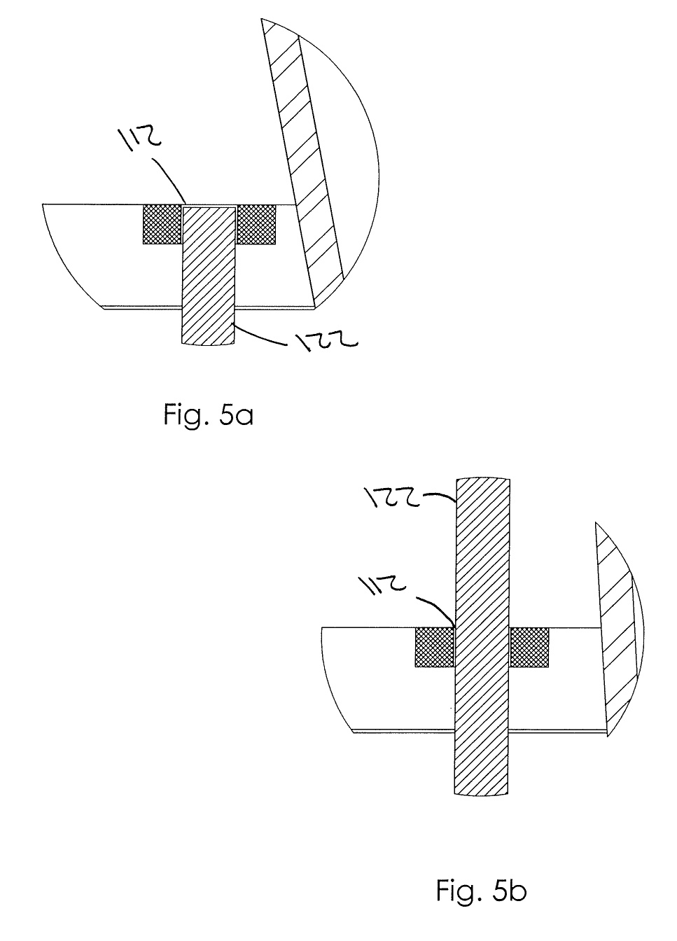

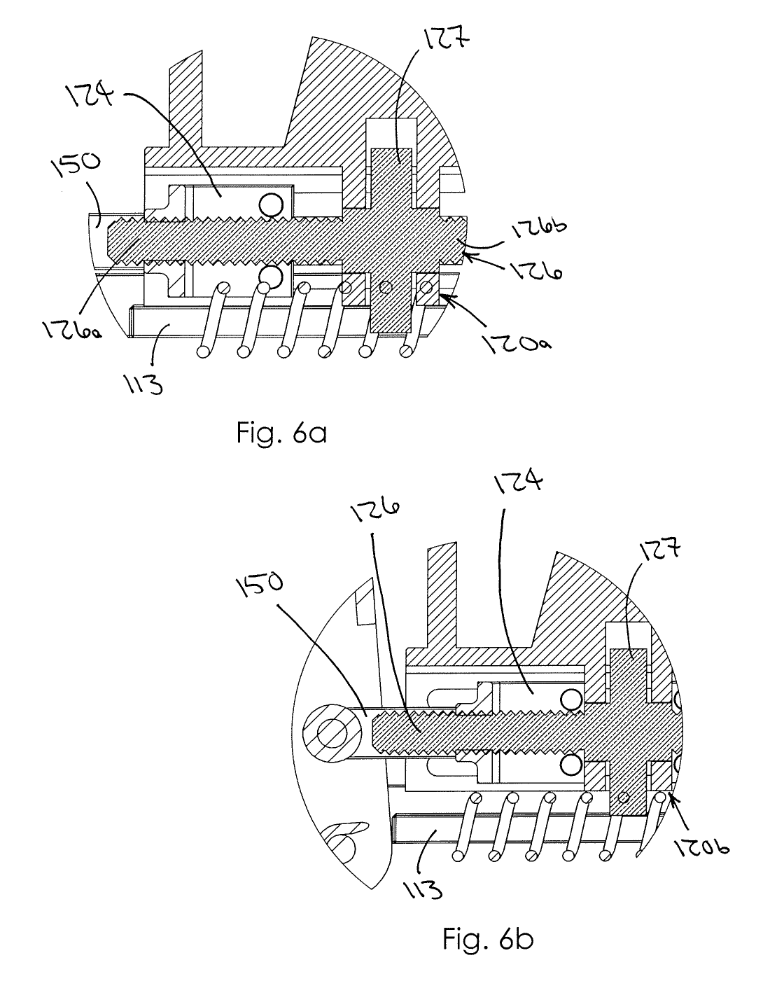

As shown in FIG. 1, the frame 110 has first and second pivot points 111a, 111b spaced apart from one another. The travel member 120 extends generally vertically between the first and second pivot points 111a, 111b and is movable generally linearly between a lowermost position 120a (FIGS. 2a and 4b) and an uppermost position 120b (FIGS. 2b and 4c). It may be preferable for the pivot points 111a, 111b to be at generally the same height and for the travel member 120 to be centered between the pivot points 111a, 111b, as shown. It should be understood that directional references used herein (e.g., uppermost, lowermost, height, etc.) are in reference to the device 100 oriented as shown in FIG. 1, but that the device 100 may be used in different orientations. As shown in FIGS. 4b, 4c, 5a, and 5b, the travel member 120 may have one or more vertical post 122, the frame 110 may include a corresponding number of apertures 112 complementary to the post(s) 122, and the vertical post(s) 122 may be positioned inside the aperture(s) 112 to restrict the travel member 120 to generally linear movement between the lowermost and uppermost positions 120a, 120b. The frame 110 may include a stop 113 (FIG. 6a) configured to interact with the travel member 120, the first intermediate link 150, and/or the second intermediate link 160 to prevent the travel member 120 from moving below the lowermost position 120a. While the frame 110 is shown in the accompanying drawings as being a unitary element, it should be understood that the frame 110 may be comprised of multiple cooperating parts.

The first and second arms 130, 140 are pivotally coupled to the frame 110 at the first and second pivot points 111a, 111b, respectively. The first intermediate link 150 is pivotally coupled to the first arm 130 and pivotally coupled to the travel member 120, and the second intermediate link 160 is pivotally coupled to the second arm 140 and pivotally coupled to the travel member 120. The first and second intermediate links 150, 160 may be collinear when the travel member 120 is at the lowermost position 120a, as shown in FIG. 2a and FIG. 4b, for example.

The travel member 120 may have first and second laterally adjustable elements 124, 125, as shown in FIGS. 4b, 4c, 6a, and 6b, and the first and second intermediate links 150, 160 may be pivotally coupled to the first and second laterally adjustable elements 124, 125, respectively. Various means may be included for moving the first and second laterally adjustable elements 124, 125 toward and away from one another. For example, the travel member 120 may include a threaded shaft 126, and the first and second laterally adjustable elements 124, 125 may respectively include threads complementary to the threaded shaft 126 such that the first laterally adjustable element 124 interacts with a first portion 126a of the threaded shaft 126 and the second laterally adjustable element 125 interacts with a second portion 126b of the threaded shaft 126. The first portion 126a of the threaded shaft 126 may be threaded in one direction and the second portion 126b of the threaded shaft 126 may be threaded in an opposite direction so that rotation of the threaded shaft 126 in one direction causes the first and second laterally adjustable elements 124, 125 to move toward one another and rotation of the threaded shaft 126 in the opposite direction causes the first and second laterally adjustable elements 124, 125 to move away from one another. An interface (e.g., wheel 127 or any other appropriate interface) is in communication with the shaft 126 to rotate the shaft 126 as desired.

Turning to FIG. 2b, a biasing element 170 (e.g., a spring, an elastic cord, etc.) may impart a force (either directly or indirectly) upon the first and/or second intermediate links 150, 160. In FIG. 2b, the force is transferred to the first and second intermediate links 150, 160 through the first and second arms 130, 140. The force biases the intermediate links 150, 160 to maintain the travel member 120 at the lowermost position 120a when the travel member 120 is at the lowermost position 120a, and the force biases the intermediate links 150, 160 to impede the travel member 120 from moving to the lowermost position 120a when the travel member 120 is not at the lowermost position 120a. A release lever 172 (FIG. 1) may be in communication with the travel member 120, the first intermediate link 150, and/or the second intermediate link 160 to selectively cause the travel member 120 to move from the lowermost position 120a, which may be especially useful if the biasing element 170 is included.

Focusing now on the first and second arms 130, 140, the first arm 130 has an upper section 132 and the second arm 140 has an upper section 142. The first pivot point 111a is between the first arm upper section 132 and the first intermediate link 150, and the second pivot point 111b is between the second arm upper section 142 and the second intermediate link 160. The first and second arm upper sections 132, 142 are closer to one another when the travel member 120 is at the lowermost position 120a than when the travel member 120 is at the uppermost position 120 such that an object may be secured between the upper sections 132, 142 when the travel member 120 is moved to and maintained at the lowermost position 120a.

A first jaw 135 may be pivotally coupled to the first arm upper section 132 at a first upper pivot point 136, and a second jaw 145 may be pivotally coupled to the second arm upper section 142 at a second upper pivot point 146, as shown in FIGS. 1 through 2b. The first jaw 135 has a contact surface 135a below the first upper pivot point 136 for contacting the object, and the second jaw 145 has a contact surface 145a below the second upper pivot point 146 for contacting the object. The first jaw 135 may be ratchetably coupled to the first arm upper section 132 at the first upper pivot point 136 such that the first jaw 135 may rotate freely only in one direction (e.g., as indicated by arrow 138 in FIG. 2b), and the second jaw 145 may be ratchetably coupled to the second arm upper section 142 at the second upper pivot point 146 such that the second jaw 145 may rotate freely only in one direction (e.g., as indicated by arrow 148 in FIG. 2b). It may be desirable for the first and second jaws 135, 145 to rotate freely only in opposite directions.

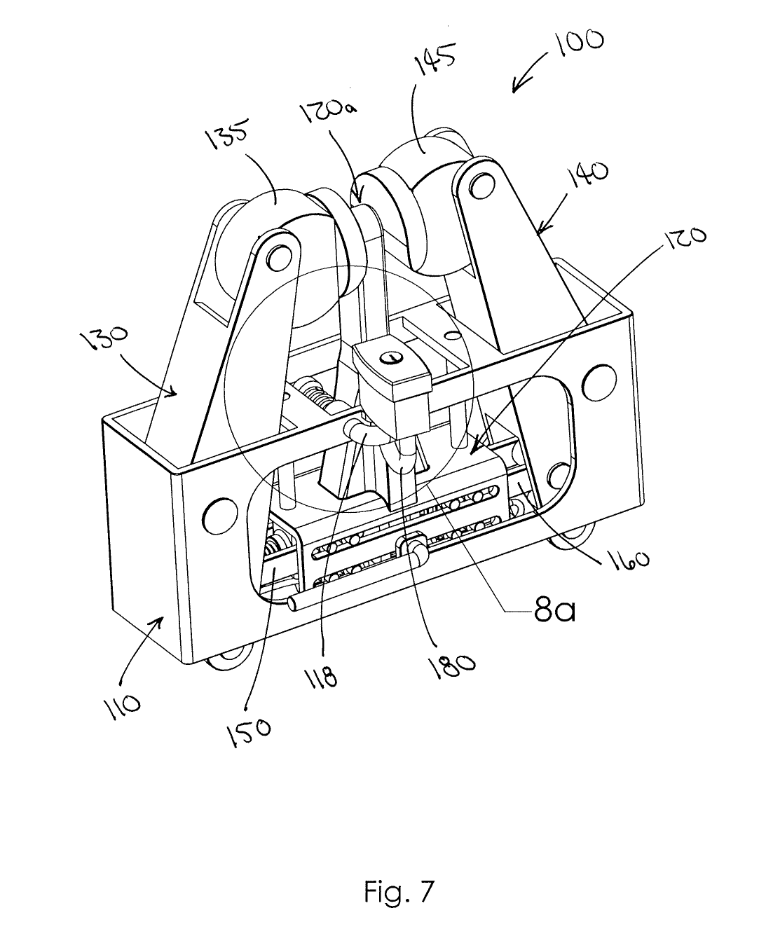

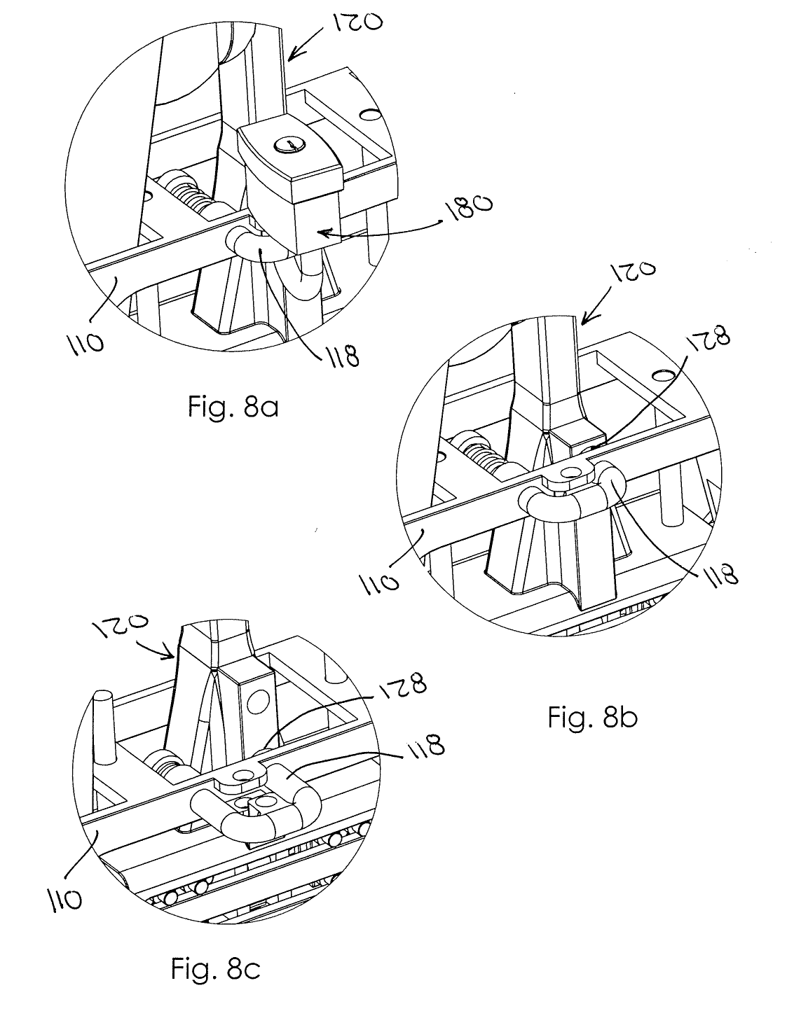

As shown in FIGS. 7 through 8c, the travel member 120 may include a hole 128, and the frame 110 may include a pin 118 that is receivable in the hole 128 when the travel member 120 is at the lowermost position 120a to further bias the travel member 120 from leaving the lowermost position 120a. A lock 180 (FIG. 8a) may be in communication with the frame 110 and the pin 118 to selectively maintain at least a portion of the pin 118 in the hole 128.

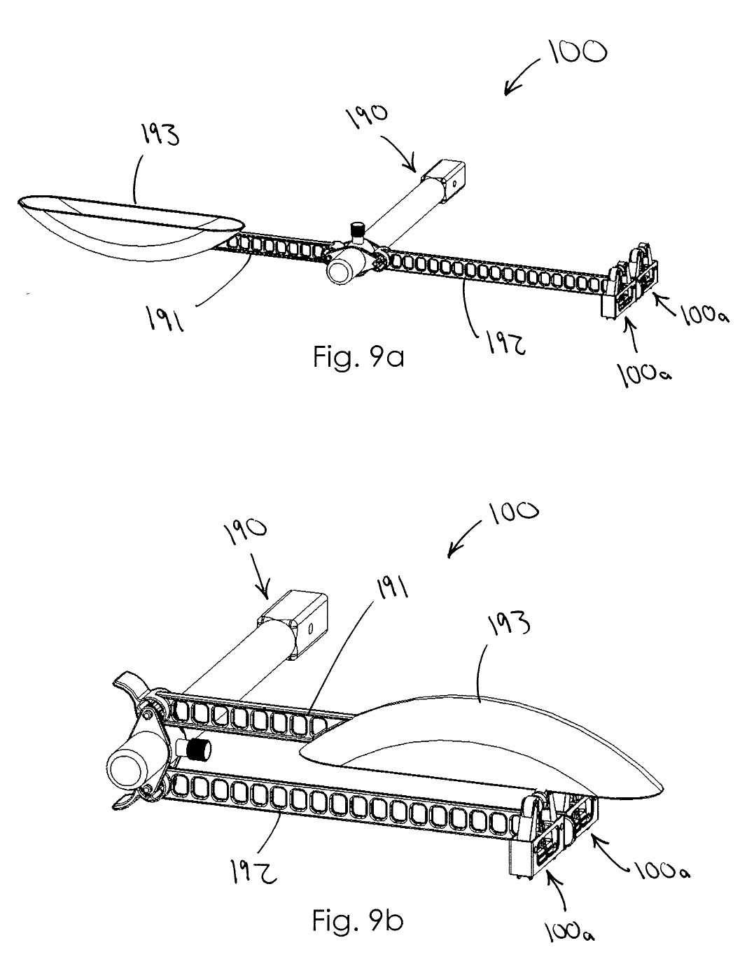

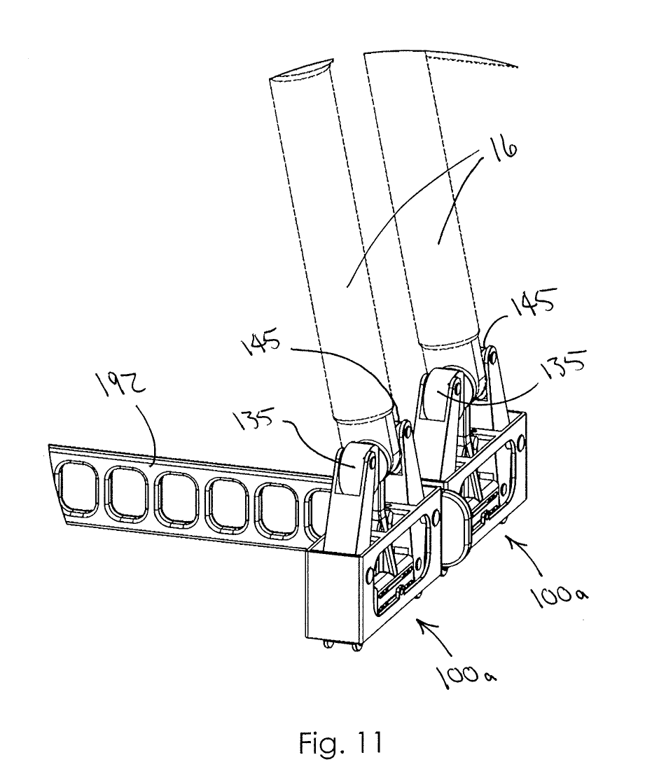

The securing device 100 described above and shown in FIGS. 1 through 8c may be thought of as a single securing unit 100a, and the securing device 100 may include multiple securing units 100a, as shown in FIG. 11. In addition, as shown in FIGS. 9a through 11, the securing device 100 may include a post 190 configured to be received in a receiver hitch 12, first and second rails 191, 192 may extend from the post 190, a tire holder 193 may be coupled to the first rail to receive a bicycle tire 14, and the securing units 100a (and more particularly their frames 110) may be coupled to the second rail 192 such that a respective fork 16 of a forked front end of a bicycle 15 may be secured between the first and second jaws 135, 145 of each securing unit 100a when the travel members 120 are at the lowermost positions 120a and the bicycle tire 14 is received in the tire holder 193. The first rail 191 and/or the second rail 192 may be movable between a use configuration (FIG. 9a) and a storage configuration (FIG. 9b).

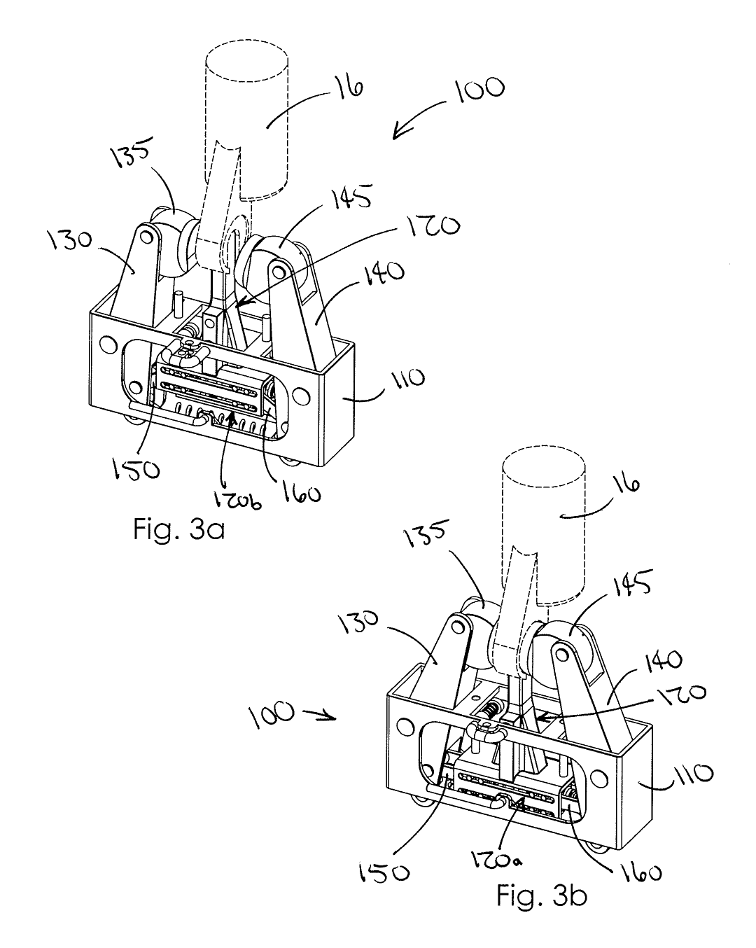

In use, focusing first on an individual securing unit 100a, the travel member 120 is initially at the uppermost position 120b (FIGS. 2b and 3a). The object (e.g., fork 16) presses on the travel member 120 and moves the travel member 120 to the lowermost position 120a (FIGS. 2a and 3b). In moving the travel member 120 to the lowermost position 120a, the force of the biasing element 170 is overcome, and the biasing element 170 then acts to retain the travel member 120 at the lowermost position 120a, as set forth above. To adjust the distance between the jaws 135, 145, the laterally adjustable elements 124, 125 may be moved, as described above. The described configuration of the jaws 135, 145 may ensure that the object (e.g., fork 16) is not released from between the jaws 135, 145 unless the arms 130, 140 are moved. The pin 118 may further keep the travel member 120 at the lowermost position 120a, and the lock 180 may be used to keep the pin 118 in place. To release the object (e.g., fork 16), the lock 180 and pin 118 may be removed and the release lever 172 may be turned to force the travel member 120 from the lowermost position 120a. The biasing element 170 may then ensure that the travel member 120 is moved to the uppermost position 120b. Attention now being directed to FIGS. 9a through 11, the post 190 may be received in the receiver hitch 12, the tire 14 may be received in the tire holder 193, and the securing units 100a may be used to secure the forks 16 of the bicycle 15.

It is understood that while certain forms of this invention have been illustrated and described, it is not limited thereto except insofar as such limitations are included in the following claims and allowable functional equivalents thereof.

1. A securing device, comprising:
a frame having first and second pivot points spaced apart from one another;
a travel member extending generally vertically between said first and second pivot points and being movable generally linearly between a lowermost position and an uppermost position;
a first arm pivotally coupled to said frame at said first pivot point;
a second arm pivotally coupled to said frame at said second pivot point;
a first intermediate link pivotally coupled to said first arm and pivotally coupled to said travel member;
a second intermediate link pivotally coupled to said second arm and pivotally coupled to said travel member, said first and second intermediate links being collinear when said travel member is at said lowermost position; and
a biasing element imparting a force directly or indirectly upon said first intermediate link, said force biasing said first intermediate link to maintain said travel member at said lowermost position when said travel member is at said lowermost position, said force biasing said first intermediate link to impede said travel member from moving to said lowermost position when said travel member is not at said lowermost position;
wherein said first arm has an upper section, said first pivot point being between said first arm upper section and said first intermediate link;
wherein said second arm has an upper section, said second pivot point being between said second arm upper section and said second intermediate link; and
wherein said first and second arm upper sections are closer to one another when said travel member is at said lowermost position than when said travel member is at said uppermost position such that an object may be secured between said upper sections when said travel member is at said lowermost position.

2. The securing device of claim 1, wherein:
said travel member has first and second laterally adjustable elements;
said first intermediate link is pivotally coupled to said first laterally adjustable element; and
said second intermediate link is pivotally coupled to said second laterally adjustable element;
and further comprising means for moving said first and second laterally adjustable elements toward and away from one another.

3. The securing device of claim 1, wherein:
said travel member has first and second laterally adjustable elements, a threaded shaft, and an interface for rotating the threaded shaft;
said first and second laterally adjustable elements respectively include threads complementary to said threaded shaft such that said first laterally adjustable element interacts with a first portion of said threaded shaft and said second laterally adjustable element interacts with a second portion of said threaded shaft;
said first portion of said threaded shaft is threaded in one direction and said second portion of said threaded shaft is threaded in an opposite direction;
rotation of said threaded shaft in one direction causes said first and second laterally adjustable elements to move toward one another; and
rotation of said threaded shaft in another direction causes said first and second laterally adjustable elements to move away from one another.

4. The securing device of claim 3, further comprising a release lever in communication with at least one of said travel member, said first intermediate link, and said second intermediate link to selectively cause said travel member to move from said lowermost position.

5. The securing device of claim 4, wherein said frame includes a stop configured to interact with at least one of said travel member, said first intermediate link, and said second intermediate link to prevent said travel member from moving below said lowermost position.

6. The securing device of claim 5, further comprising:
a first jaw pivotally coupled to said first arm upper section at a first upper pivot point, said first jaw having a contact surface for contacting said object, said first jaw contact surface being below said first upper pivot point; and
a second jaw pivotally coupled to said second arm upper section at a second upper pivot point, said second jaw having a contact surface for contacting said object, said second jaw contact surface being below said second upper pivot point.

7. The securing device of claim 6, wherein:
said first jaw is ratchetably coupled to said first arm upper section at said first upper pivot point such that said first jaw may rotate freely only in one direction; and
said second jaw is ratchetably coupled to said second arm upper section at said second upper pivot point such that said second jaw may rotate freely only in one direction, said first and second jaws being freely rotatably in opposite directions.

8. The securing device of claim 7, wherein:
said travel member includes at least one hole; and
said frame includes a pin receivable in said hole when said travel member is at said lowermost position;
and further comprising a lock in communication with said frame and said pin to selectively maintain at least a portion of said pin in said hole.

9. The securing device of claim 8, wherein said travel member has a vertical post, said frame includes an aperture complementary to said vertical post, and said vertical post is positioned inside said aperture to restrict said travel member to generally linear movement between said lowermost and uppermost positions.

10. The securing device of claim 9, wherein said object is a portion of a bicycle; further comprising:
a post configured to be received in a receiver hitch;
first and second rails extending from said post; and
a tire holder coupled to said first rail to receive a bicycle tire;
and wherein said frame is coupled to said second rail such that said object may be secured between said first and second jaws when said travel member is at said lowermost position and said bicycle tire is received in said tire holder.

11. The securing device of claim 10, wherein:
said object is one fork of a forked front end of a bicycle; and
at least one of said first and second rails is movable between use and storage configurations.

12. The securing device of claim 1, further comprising a release lever in communication with at least one of said travel member, said first intermediate link, and said second intermediate link to selectively cause said travel member to move from said lowermost position.

13. The securing device of claim 1, further comprising:
a first jaw pivotally coupled to said first arm upper section at a first upper pivot point, said first jaw having a contact surface for contacting said object, said first jaw contact surface being below said first upper pivot point; and
a second jaw pivotally coupled to said second arm upper section at a second upper pivot point, said second jaw having a contact surface for contacting said object, said second jaw contact surface being below said second upper pivot point.

14. The securing device of claim 13, wherein:
said first jaw is ratchetably coupled to said first arm upper section at said first upper pivot point such that said first jaw may rotate freely only in one direction; and
said second jaw is ratchetably coupled to said second arm upper section at said second upper pivot point such that said second jaw may rotate freely only in one direction, said first and second jaws being freely rotatably in opposite directions.

15. The securing device of claim 1, wherein:
said travel member includes at least one hole; and
said frame includes a pin receivable in said hole when said travel member is at said lowermost position;
and further comprising a lock in communication with said frame and said pin to selectively maintain at least a portion of said pin in said hole.

16. The securing device of claim 1, wherein said travel member has a vertical post, said frame includes an aperture complementary to said vertical post, and said vertical post is positioned inside said aperture to restrict said travel member to generally linear movement between said lowermost and uppermost positions.
